(19) United States
(12) Patent Application Publication
(10) Pub. No.: US 2002/0165820 A1
(43) Pub. Date: Nov. 7, 2002

(54) Prepaid electronic cash system with pin vending machines

(76) Inventors: Dinesh Kashinath Anvekar, Edison, NJ (US); Bhaskarpillai Gopinath, Watchung, NJ (US); Sanjay Gupta, Edison, NJ (US)

Correspondence Address: John T. Peoples, 14 Blue Jay Court, Warren, NJ, 07059, US

(21) Appl. No.: 09/848,795

(22) Filed: May 4, 2001

(51) Int. Cl. G06F 17/60

(52) U.S. Cl. 705/39

(57) ABSTRACT

A technique for delivery of a personalized identification number (PIN) from a centralized database of a prepaid PIN service provider along with a digital signature for verification of the transaction. As a response to a cash amount inputted by the user to a PIN vending machine, an unassigned PIN in a centralized database is assigned to the user as a unique user PIN, and delivered to the user as an imprinted receipt along with an associated digital signature for authentication.

### BACKGROUND OF THE DISCLOSURE

1. Field of the Invention

This invention relates generally to an electronic prepaid cash system and, more particularly, to a methodology and a concomitant system whereby a user can purchase a personal identification number (PIN) by depositing cash in a PIN vending machine and obtain a receipt with a PIN and a digital signature as a proof of purchase.

2. Description of the Background Art

Presently prepaid card systems are used mainly for long-distance telephone calls. However, it is widely anticipated that prepaid cards will be soon introduced for buying various kinds of products and services. Privacy, anonymity and ability to limit spending are some beneficial features of prepaid cards.

A major disadvantage of many existing prepaid card systems is that personal identification numbers (PINs) have to be physically printed on cards and the cards have to be distributed to the sellers of the cards, and in turn, to the purchasers of the cards. Some prepaid card systems obviate the need to distribute the cards by making them available as virtual cards on the Internet. As an example, a known method of prepaid calling card system not requiring physical cards uses the Internet to provide the PIN or the account access number (http://www.wqn.com/cards.asp). However, this system requires the user to have a credit/debit card account and enter the credit/debit card number to buy the account. A limitation of such Internet-based approaches is that the user has to provide sensitive information such as his credit/debit card number for purchase of such cards. Also, identity of the buyer is revealed in this approach. Further, the user should have access to a computer with an Internet browser.

The ability to anonymously purchase and use prepaid cards is highly desirable for many forms of commerce. Therefore, a system wherein a user can buy prepaid cards from vending machines without revealing any personal identity is very useful in practice. An example of such a PIN-vending dispenser can be found U.S. Pat. No. 5,868,236 issued to Rademacher. The phone card vending machine of Rademacher has: (a) a secure, locking cabinet; (b) a card dispenser; (c) a bill acceptor or similar cash acceptor; (d) a printer for printing slip receipts containing an activated PIN; (e) and a controller board within the cabinet and connected to the dispenser, printer, and cash acceptor. The card dispenser contains a supply of zero-value telephone cards. The controller board has a PIN memory that stores PINs for each of several amounts of long distance calling time. The customer purchases a card by inserting paper currency or coins, and making a selection from a keypad on the cabinet. The customer can select from eight (or more) different dollar values, and then press a select button to dispense the card. At the time the card is dispensed, the printer also prints and dispenses a paper receipt that shows the purchase price, including any relevant taxes, the amount of long distance service time purchased, and the PIN. The vending machine can replenish its stock of activated PINs by modem from a remote location. A limitation of this system is that activated PINs are downloaded and stored in the local memory of the vending machine. This ties up the PINs with the vending machine until they are purchased. In practice, it is desirable to allocate PINs to vending machines only at the time of purchase. This allows any escrow amount of an owner of vending machines to be utilized through any of the vending machines that the merchant owns. Another limitation of such a PIN vending system is that a user can purchase only pre-defined values. So, there is a need for a PIN vending system wherein a user is permitted to buy a PIN of any value up to a maximum limit. Yet another limitation of the prepaid card dispenser is that the receipt is produced on plain paper slip and the printed information on the receipt is insufficient to validate the authenticity of purchase of the PIN through that vending machine.

### SUMMARY OF THE INVENTION

These shortcomings and other limitations and deficiencies are obviated in accordance with the present invention by a method, and concomitant system, to provide for delivery of a PIN from a centralized database of a prepaid service provider along with a digital signature for verification of the transaction.

In accordance with a broad method aspect of the present invention, a method for delivering a unique personal identification number (PIN) representative of a cash amount inputted by a user into a PIN vending machine supplied by a merchant, includes: (a) storing in a centralized database a plurality of personal identification numbers (PINs) and an escrow amount associated with the merchant; (b) in response to the cash amount inputted by the user, allocating an unassigned one of the PINs as the unique PIN and subtracting the inputted cash amount from the escrow amount; and (c) dispensing to the user from the vending machine the unique PIN along with an associated digital signature.

In accordance with another broad method aspect of the present invention, a method for transmitting a unique personal identification number (PIN) representative of a cash amount inputted by a user into a PIN vending machine supplied by a merchant includes: (a) storing in a centralized database a plurality of personal identification numbers (PINs) and an escrow amount associated with the merchant; (b) allocating an unassigned one of the PINs as the unique PIN in response to the cash amount inputted by the user, and subtracting the inputted cash amount from the escrow amount; and (c) sending to the user the unique PIN along with information for providing an associated digital signature.

In accordance with a broad system aspect for delivering a unique personal identification number (PIN) representative of a cash amount inputted by a user into a PIN vending machine supplied by a merchant, the system includes: (a) a storage device for storing in a centralized database a plurality of personal identification numbers (PINs) and an escrow amount associated with the merchant; (b) a processor, operative in response to the cash amount inputted by the user and coupled to the storage device, for allocating an unassigned one of the PINs as the unique PIN and for subtracting the inputted cash amount from the escrow amount; and (c) a dispenser, responsive to the processor, for dispensing to the user from the vending machine the unique PIN along with an associated digital signature.

### BRIEF DESCRIPTION OF THE DRAWINGS

The teachings of the present invention can be readily understood by considering the following detailed description in conjunction with the accompanying drawings, in which:

FIG. 1 illustrates a high-level block diagram of a prepaid account system based on PIN vending machines in accordance with the present invention;

FIG. 2 depicts a schematic representation of an embodiment of prepaid accounts server of FIG. 1;

FIG. 3 illustrates an arrangement for the VMO database of FIG. 2;

FIG. 4 illustrates an arrangement for the PIN database of FIG. 2;

FIG. 5 illustrates an arrangement for the vending machine database of FIG. 2;

FIG. 6 shows a flow diagram for an illustrative process in accordance with the present invention; and

FIG. 7 illustrates the layout of a receipt presented to the user.

To facilitate understanding, identical reference numerals have been used, where possible, to designate identical elements that are common to the figures.

### DETAILED DESCRIPTION

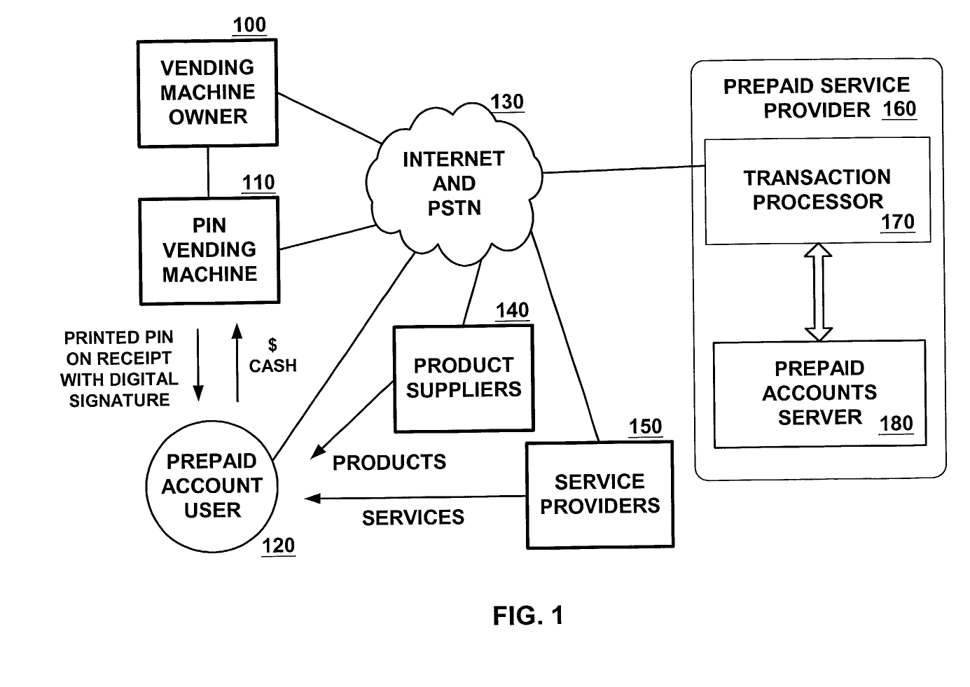

A schematic representation of a prepaid account system based on PIN vending machines in accordance with the present invention is shown in FIG. 1. In this system, a designated PIN vending machine owner (VMO) 100 who is registered with the prepaid service provider 160 controls the sale of PINs through a PIN vending machine 110 that the VMO owns. VMO 100 deposits or charges an amount of money as an escrow account with prepaid service provider 160 against PINs that the VMO wishes to sell through the vending machines owned by the VMO. After this registration of the VMO, a prepaid account user 120 can purchase PINs through the vending machines owned by that VMO.

A user deposits cash in terms of paper currency or coins into a vending machine 110 and selects, via the keys on the vending machine (not shown, but conventional), the value of a PIN that the user wishes to purchase—this activity may be characterized as a user request transaction. PIN vending machine 110 is connected to the transaction processor 170 of the prepaid service provider 160 through the Internet/PSTN 130 or other conventional communication arrangements. After receiving the cash and instruction from the user for purchasing a unique PIN, PIN vending machine 110 sends a request to the transaction processor 170 for issuance of a PIN against the prepaid account of VMO 100. Transaction processor 170 is connected to a prepaid accounts server 180 that stores the databases for a plurality of VMOs and the PINs assigned under each of their accounts as a centralized database. Transaction processor 170 then verifies the availability of escrow amount for the VMO associated with the current user, and assigns a unique PIN to the current user and sends the PIN data to vending machine 110. The prepaid account of the particular VMO is then decreased by the PIN amount in server 180.

As a transaction response to the user request transaction, vending machine 100 responds by printing the unique user PIN on a paper tape or card or suitable medium for delivery to the user (conventional imprinting mechanism is not shown). As a receipt for the PIN amount, vending machine 110 also prints a unique digital signature along with the PIN. Well-known public key cryptographic techniques can be used to produce the digital signature. For example, unique identification information pertaining to vending machine 110 along with information such as date and time of purchase can be encrypted using a private key of vending machine 110 and printed on the receipt as a digital signature. The digital signature may then be used to authenticate validity of PIN purchased by the user using the public key known to the prepaid service provider and VMOs. The generation of a digital signature provides protection against imposters attempting to forge fake PINs and claiming rights to use the prepaid PIN.

The user can then use the PIN for anonymous purchase of products and services from product suppliers 140 and other service providers 150 by ordering through known channels such as the Internet/PSTN 130. Alternatively, the users can get the products and services at the premises of the sellers via the popularly used Point-Of-Sale(POS) terminals. Product suppliers 140 or service providers 150 contact the transaction processor 170 via Internet/PSTN 130 or other communication means when they receive a request to provide products or services against PINs issued through the prepaid service provider. Transaction processor 170 verifies the validity of each PIN and the corresponding available amount and sends an authorization message to the product suppliers 140 or service providers 150 to fulfill the requests of users. Transaction processor 170 decrements the prepaid stored value of the particular user PIN after receiving confirmation of product delivery or service completion from the product suppliers or service providers. In the case of incrementally utilized services such as prepaid long-distance calling, the transaction processor may receive additional information from the service providers 150 regarding the charge for the services utilized.

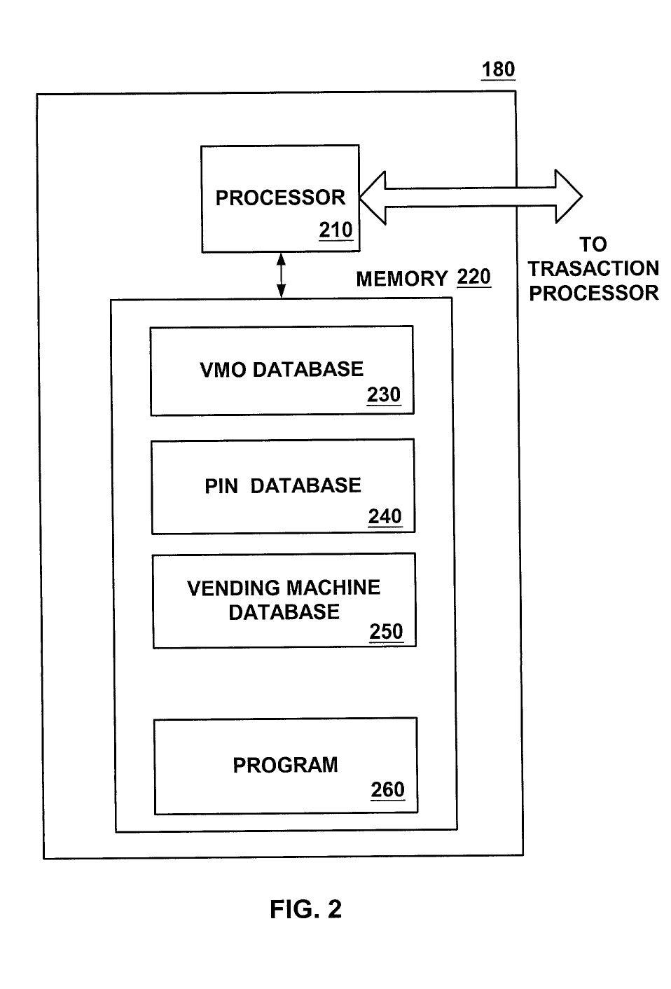

Referring next to FIG. 2, a schematic representation of an embodiment of prepaid accounts server 180 is shown. Server 180 typically includes memory 220, and at least one processor 210 in communication therewith. Memory 220 typically includes one or more machine-readable media. Such media include, as is well known in the art, an appropriate combination of magnetic, semiconductor and optical media. Memory 220 is preferably capable of supporting searching and storing of digital data such as text. Memory 220 (or portions thereof) may reside on single computer, or may be distributed in a known manner among multiple computers that may be included in the server.

In the present embodiment, memory 220 includes VMO database 230, PIN database 240 and vending machine database 250. Memory 220 also stores a program 260, which includes instructions for controlling the processor 210 in accordance with the present invention, and particularly in accordance with the process described herein.

The rows and columns of the databases 230, 240, and 250 described herein represent records and fields thereof, respectively. In the described embodiments, the databases are used in a relational arrangement, as is known in the art, so that the databases relate to one another by way of fields that store common data. It is to be noted that while the following description refers to specific individual databases, formats, records, and fields, those skilled in the art will readily appreciate that various modifications and substitutions may be made thereto without departing from the spirit and scope of the present invention.

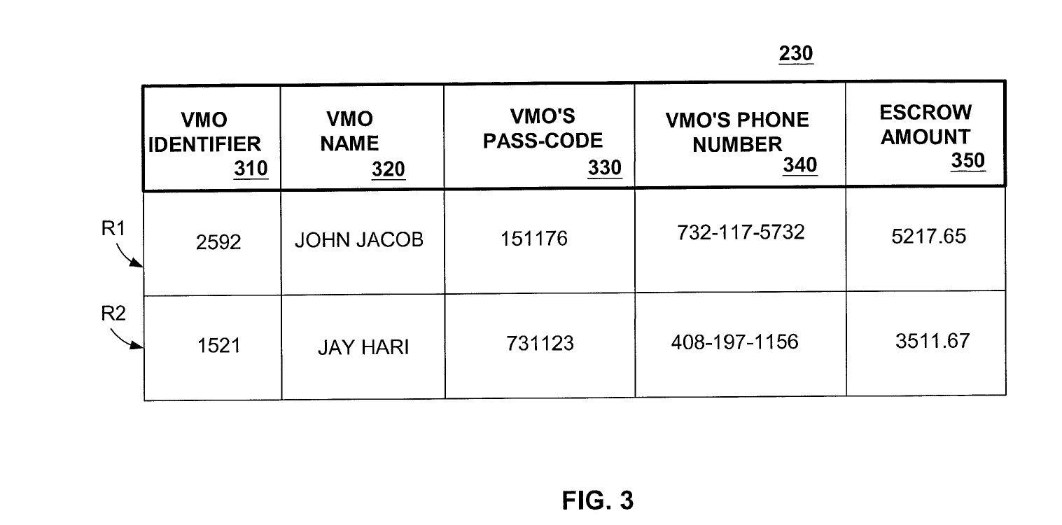

Referring now to FIG. 3, an embodiment of VMO database 230 is depicted in detail. Database 230 stores data relating to VMO accounts that are maintained for account holders. Each record (row) of database 230 represents such an account. For exemplary purposes, two records R1 and R2 are shown.

Field 310 stores a VMO identifier that is associated with and uniquely identifies a VMO account. In this embodiment, the VMO identifier is a four-digit VMO number. The number of digits in this filed can be fixed depending on the maximum expected number of VMOs in any prepaid account system. Of course, other types of numerical or alphanumeric account identifiers may be used as desired.

Field 320 is used to store the name of a VMO. Field 330 is used to store the pass-code of the VMO identified in fields 310 and 320. In this embodiment, the pass-code is a six-digit number. The number of digits in this field can be fixed depending on any particular implementation of the system and the required amount of security. The pass-code is required by a VMO to access the prepaid accounts server and know the details of his/her account. Field 340 is used to store VMO's phone number. It possible to store multiple possible phone numbers here.

Field 350 stores the escrow amount in the credit of each VMO's account. The currency for storage of the escrow amount can be different depending on the country where the system is implemented. Alternatively, a common currency unit could be used and appropriate currency exchange can be performed corresponding to any transaction for the account.

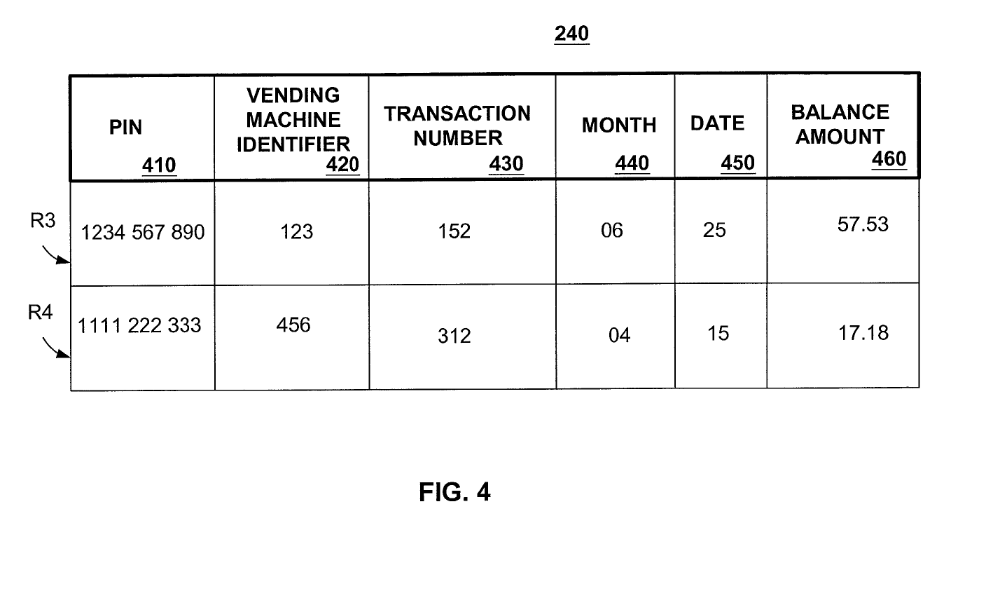

Referring next to FIG. 4, an embodiment of PIN database 240 is depicted in detail. Database 240 stores data relating to one or more PINs. One record (row) of database 240 is maintained for each PIN account. For exemplary purposes, two records designated R3 and R4 are shown. Field 410 stores the digits of a PIN. Field 420 stores the vending machine identifier. Field 430 is used to store a transaction number that identifies the sale of PIN through the vending machine identified in field 420. Field 440 stores the month and field 450 the date when the transaction was performed. The balance amount available against the PIN is stored in field 460. The amount in this field is updated when a user purchases products or services using the PIN or when an additional amount is added from the amount available against another PIN as for example, when a user wishes to merge two or more PIN accounts into a single account. It is possible to have PINs of different types each with its set of privileges and restrictions. For example, a type of PIN may be restricted for buying only books from a known set of stores.

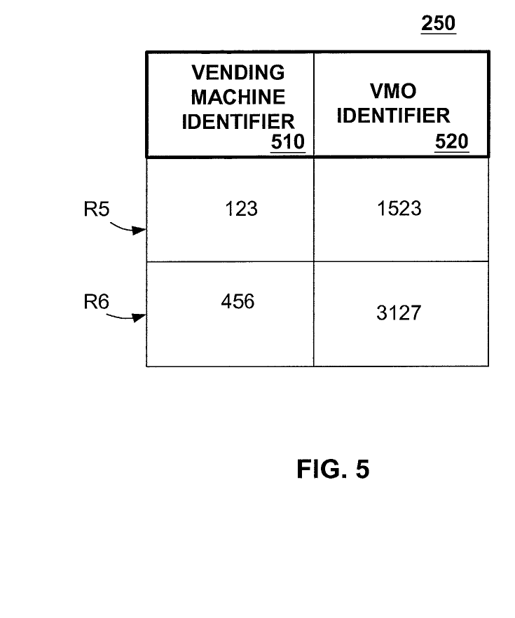

FIG. 5 shows a vending machine database 250 that indicates the owners of vending machines. Field 510 stores a vending machine identifier number and field 520 stores the VMO identifier of the owner of the vending machine. Alternatively, it is possible to store lists of vending machine identifiers of vending machines owned by VMOs.

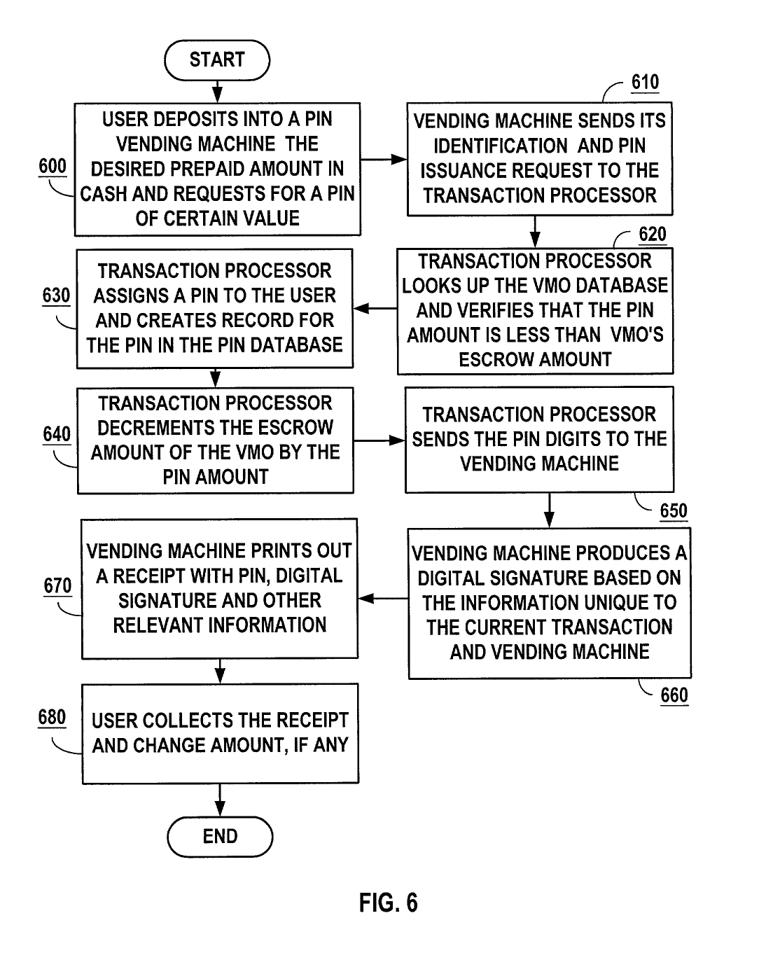

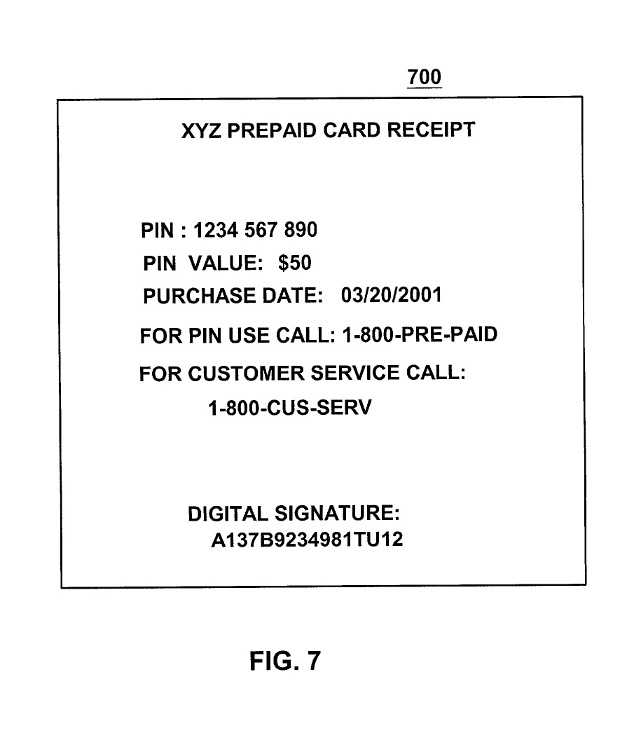

Referring now to FIG. 6, a flowchart for the PIN issuance process is shown. A user approaches PIN vending machine 100 and deposits a certain amount into the vending machine to buy a PIN account as in process step 600. The user indicates via the keyboard on the vending machine the type and monetary value of the PIN. Processing step 610 is then invoked so that the vending machine then sends its identification and PIN issuance instruction to transaction processor 170 via the Internet/PSTN 130 or similar communication means. The vending machine also sends other information such as the transaction number, and month and date of the transaction. The transaction number can be simply the serial number of the PIN sold by the vending machine on any particular day. Next in Step 620, the transaction processor looks up the VMO database to ascertain whether sufficient escrow amount is available to issue the PIN. If it is found that the PIN can be issued, then in Step 630 the transaction processor assigns a PIN to the user by picking up the next available PIN from a pool of pre-generated PIN numbers. In step 640, the transaction processor decrements the escrow amount of the VMO by the PIN amount sold in the current transaction. It is possible that the amount by which the escrow amount is decremented is less than the PIN amount due to any commissions the prepaid service provider may give to the VMOs. Next, in step 650, the PIN digits are sent to the vending machine. For security in communications well-known methods of encryptions and decryption may be adopted to transmit the PIN to the vending machines. The vending machine then generates, in step 660, a digital signature based on information unique to the current transaction and the vending machine. For example, vending machine identification number and date and time of issuance of PIN may be used to produce the digital signature. Next in step 670, the vending machine imprints the PIN on a receipt as well as the digital signature and other relevant information useful to the user. A typical receipt 700 is shown in FIG. 7. The user collects the receipt and change amount, if any, in step 680 from the vending machine. It is also possible to print the PIN on a separate card and issue the receipt with the digital signature separately. After the PIN is obtained, the user can at any time enter the PIN number via the keyboard of a vending machine and get the information about the available balance amount. Also, amounts from two or more PINs may be consolidated into a single PIN at the vending machine. Some other alternative means by which a user may access his account information include telephone-based access and Internet-based access.

Although the teachings of the present invention have been shown and described in detail herein, those skilled in the art can readily devise many other varied embodiments that still incorporate these teachings. Thus, the previous description merely illustrates the principles of the invention. It will thus be appreciated that those with ordinary skill in the art will be able to devise various arrangements which, although not explicitly described or shown herein, embody principles of the invention and are included within its spirit and scope. Furthermore, all examples and conditional language recited herein are principally intended expressly to be only for pedagogical purposes to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, that is, any elements developed that perform the function, regardless of structure.

In addition, it will be appreciated by those with ordinary skill in the art that the block diagrams herein represent conceptual views of illustrative systems and sub-systems embodying the principles of the invention.

What is claimed is:

1. A method for delivering a unique personal identification number (PIN) representative of a cash amount inputted by a user into a PIN vending machine supplied by a merchant, the method comprising
storing in a centralized database a plurality of personal identification numbers (PINs) and an escrow amount associated with the merchant,
allocating an unassigned one of the PINs as the unique PIN in response to the cash amount inputted by the user, and subtracting the inputted cash amount from the escrow amount, and
dispensing to the user from the vending machine the unique PIN along with an associated digital signature.

2. The method as recited in claim 1 wherein the dispensing includes imprinting a receipt with the unique PIN and the digital signature.

3. The method as recited in claim 1 wherein the vending machine has a unique identifier and the dispensing includes generating the digital signature with reference to the unique vending machine identifier.

4. The method as recited in claim 1 wherein the vending machine has a unique identifier and the dispensing occurs at a given date and time, and the dispensing includes generating the digital signature with reference to the unique vending machine identifier and given time and date.

5. A method for delivering a unique personal identification number (PIN) representative of a cash amount inputted by a user into a PIN vending machine supplied by a merchant wherein the vending machine has a unique identifier, the method comprising
storing in a centralized database a plurality of personal identification numbers (PINs) and an escrow amount associated with the merchant,
allocating an unassigned one of the PINs as the unique PIN in response to the cash amount inputted by the user and subtracting the inputted cash amount from the escrow amount, and
dispensing to the user from the vending machine the unique PIN along with an associated digital signature indicative of the unique identifier and information corresponding to the dispensing of the unique PIN.

6. The method as recited in claim 5 wherein the dispensing includes imprinting a receipt with the unique PIN and the digital signature.

7. The method as recited in claim 5 wherein the dispensing occurs at a given date and time, and the dispensing includes generating the digital signature with reference to the unique vending machine identifier and given time and date.

8. The method as recited in claim 7 wherein the dispensing includes imprinting a receipt with the unique PIN and the digital signature.

9. A method for delivering a unique personal identification number (PIN) representative of a cash amount inputted by a user into a PIN vending machine supplied by a merchant, the method comprising the steps of
storing in a centralized database a plurality of personal identification numbers (PINs) and an escrow amount associated with the merchant,
allocating an unassigned one of the PINs as the unique PIN in response to the cash amount inputted by the user, and subtracting the inputted cash amount from the escrow amount, and
dispensing to the user from the vending machine the unique PIN along with an associated digital signature.

10. The method as recited in claim 9 wherein the step of dispensing includes the step of imprinting a receipt with the unique PIN and the digital signature.

11. The method as recited in claim 9 wherein the vending machine has a unique identifier and the step of dispensing includes the step of generating the digital signature with reference to the unique vending machine identifier.

12. The method as recited in claim 9 wherein the vending machine has a unique identifier and the step of dispensing occurs at a given date and time, and the step of dispensing includes the step of generating the digital signature with reference to the unique vending machine identifier and given time and date.

13. A method for transmitting a unique personal identification number (PIN) representative of a cash amount inputted by a user into a PIN vending machine supplied by a merchant, the method comprising
storing in a centralized database a plurality of personal identification numbers (PINs) and an escrow amount associated with the merchant,
allocating an unassigned one of the PINs as the unique PIN in response to the cash amount inputted by the user, and subtracting the inputted cash amount from the escrow amount, and
sending to the user the unique PIN along with information for providing an associated digital signature.

14. A method for receiving a unique personal identification number (PIN) representative of a cash amount inputted by a user into a PIN vending machine supplied by a merchant, the method comprising
sending from the vending machine to a centralized database containing a plurality of personal identification numbers (PINs) a request for an allocation of the unique PIN in response to the cash amount inputted by the user,
receiving an allocated one of the PINs as the unique PIN, and
dispensing to the user from the vending machine the unique PIN along with an associated digital signature.

15. A method for receiving a unique personal identification number (PIN) representative of a cash amount inputted by a user into a PIN vending machine supplied by a merchant, the method comprising
controlling a sending component, in response to the cash amount inputted by the user, to send from the vending machine to a centralized database containing a plurality of personal identification numbers (PINs) a request for an allocation of the unique PIN,
controlling a receiving component to receive an allocated one of the PINs as the unique PIN, and
controlling a dispensing component to dispense to the user from the vending machine the unique PIN along with an associated digital signature.

16. A method for transacting the purchase of a user PIN between a vending machine assigned to a merchant and a remotely located service provider coupled to the vending machine, the method comprising the steps of
storing a plurality of personal identification numbers (PINs) in a centralized PIN database of the service provider,
storing an escrow amount for the merchant in a merchant database of the service provider,
inputting by the user a specific cash amount into the vending machine,
transmitting a request to the service provider to allocate an unassigned one of the PINs as a unique user PIN and to subtract the specific cash amount from the escrow amount,
transmitting a response to the vending machine including the unique user PIN, and
dispensing the unique user PIN to the customer along with an associated digital signature representative of the response.

17. The method as recited in claim 16 wherein the vending machine has a unique identifier and the step of dispensing includes the step of generating the digital signature with reference to the unique vending machine identifier and the time and date of the response.

18. The method as recited in claim 17 wherein the step of dispensing includes the step of imprinting a receipt with the unique user PIN and the digital signature.

19. A method for purchasing a prepaid cash card from a vending machine provided to a customer by a merchant, the method comprising the steps of
storing a plurality of personal identification numbers (PINs) in a centralized PIN database of a service provider,
storing an escrow amount for the merchant in a merchant database of the service provider,
forwarding a transaction request from vending machine to the service provider in response to the customer inputting a specific cash amount into the vending machine,
allocating an unassigned one of the stored PINs as a unique customer PIN in response to the transaction request and subtracting the specific amount from the escrow amount, and
dispensing to the customer from the vending machine the prepaid cash card and a receipt imprinted with the unique customer PIN and a digital signature.

20. The method as recited in claim 19 wherein the vending machine has a unique identifier and the step of dispensing includes the step of generating the digital signature with reference to the unique vending machine identifier and the time and date of the transaction response.

21. A system for delivering a unique personal identification number (PIN) representative of a cash amount inputted by a user into a PIN vending machine supplied by a merchant, the system comprising
a storage device for storing in a centralized database a plurality of personal identification numbers (PINs) and an escrow amount associated with the merchant,
a processor, operative in response to the cash amount inputted by the user and coupled to the storage device, for allocating an unassigned one of the PINs as the unique PIN and for subtracting the inputted cash amount from the escrow amount, and
a dispenser, responsive to the processor, for dispensing to the user from the vending machine the unique PIN along with an associated digital signature.

22. A system for receiving a unique personal identification number (PIN) representative of a cash amount inputted by a user into a PIN vending machine supplied by a merchant, the system comprising
means, responsive to the cash amount inputted by the user, for sending from the vending machine to a centralized database containing a plurality of personal identification numbers (PINs) a request for an allocation of the unique PIN,
means for receiving an allocated one of the PINs as the unique PIN, and
means for dispensing to the user from the vending machine the unique PIN along with an associated digital signature.

23. The system as recited in claim 22 wherein the means for dispensing includes means for imprinting a receipt with the unique PIN and the digital signature.

24. The system as recited in claim 22 wherein the vending machine has a unique identifier and the means for dispensing includes means for generating the digital signature with reference to the unique vending machine identifier.

25. The system as recited in claim 22 wherein the vending machine has a unique identifier and the means for dispensing occurs at a given date and time, and the means for dispensing includes means for generating the digital signature with reference to the unique vending machine identifier and given time and date.
